(19) United States
(12) Patent Application Publication
(10) Pub. No.: US 2009/0061941 A1
(43) Pub. Date: Mar. 5, 2009

(54) Telecommunications antenna monitoring system

(76) Inventor: Steve Clark, Seattle, WA (US)

Correspondence Address: LAURENCE C. BONAR, 917 LOGAN ST, PORT TOWNSEND, WA, 98368-2337, US

(21) Appl. No.: 12/288,276

(22) Filed: Oct. 16, 2008

Related U.S. Application Data
(63) Continuation-in-part of application No. 11/725,996, filed on Mar. 19, 2007.
(60) Provisional application No. 60/783,571, filed on Mar. 17, 2006.

(51) Int. Cl. H04M 1/00; G06F 15/00

(52) U.S. Cl. 455/562.1; 702/188

(57) ABSTRACT

The present invention provides systems and methods for determining positional and operating parameters of telecommunications antennae, and for improving the operation of systems of such antennae. In one aspect, the invention provides an enterprise for improving the operation of the telecommunications antennae of clients of the enterprise.

This application claims priority from U.S. patent application Ser. No. 11/725,996, filed Mar. 19, 2007, which claims priority from U.S. patent application Ser. No. 60/783,571, filed Mar. 17, 2006.

### TECHNICAL FIELD OF THE INVENTION

This invention relates to systems for monitoring telecommunications antenna installations.

### BACKGROUND

Wireless telecommunications (“T/C”) systems are being used increasingly for both voice and data communications. There were more than 180 million cell phones users in the US in 2002, a number that has undoubtedly increased sharply since then. Cell phones are even more prevalent in many foreign countries. Other forms of wireless T/C include: microwave data and voice transmission by public utilities and private entities; short-wave communications systems between a businesses central office or dispatcher and mobile fleets of trucks, taxicabs, etc; police, fire and other public safety radio communications systems; marine short-wave radio systems; etc. With the great increase in recent years in wireless T/C systems—especially cell phones—and the vigorous competition between T/C service providers, there has been a great increase in the number of transmitting/receiving antenna installations needed. (For brevity, wireless T/C transmitting/receiving antenna installations will hereinafter generally be referred to as “T/C towers” or simply “towers”, although many such installations are mounted on buildings or other structures, especially in urban areas, rather than on free-standing tower structures.) In many cases antennae from more than one T/C service provider (hereinafter “providers” for brevity) and more than one T/C mode may be mounted on a tower.

The following discussion will focus on cell phone systems and towers, since this application accounts for most of the T/C tower installations in current use. However, it will be appreciated that the matters discussed will apply equally to other T/C applications.

It is estimated that there are more than 100,000 cell phone towers in the US. Cell phone service providers providing nationwide service typically divide their operations into a half-dozen or so regional offices, each of which includes a number of local offices serving either a large city and it's surrounding area, or a rural area. A large provider in a large city area will typically have 1,500 or more towers with 10,000 or more individual antennae.

A typical tower will have three antennae oriented about 120° apart horizontally (i.e., azimuth) to serve three sectors of its service area, and may be aimed at an angle above or below the horizontal (“tilt”). In some installation, separate receive and transmit antennae may be employed, so there may be 3 or 5 antennae per sector. “Omnis”—omnidirectional antennae radiating equally in all horizontal directions—may also be employed.

Cell phone service can be provided by any of several different T/C protocols and can use one of several wavelength bands available for cell phone service. Each cell phone mode—i.e, combination of protocol and wavelength band—will require a separate set of antennae; the multiplicity of antennae for the different cell phone modes serving a given area are typically mounted on the same tower.

In what follows, antenna azimuth will refer to the angle in a horizontal plane between the axis of the antenna's radiation pattern and a reference direction such as true or magnetic north; antenna tilt will refer to the angle, in a vertical plane, between the axis of the antenna's radiation pattern and horizontal; antenna roll will refer to the angle, in a substantially vertical plane normal to the axis of the antenna's radiation pattern, by which an antenna's actual alignment departs from the alignment the antenna was designed to operate in.

In addition to azimuth, tilt and roll, each antenna may be characterized by geographic position (i.e., longitude and latitude) and height (either absolute height, relative to sea level, or height above local ground), and the specific type or model of the antenna and auxiliary equipment mounted with it.

Each tower will have an associated base station, which includes power supplies, radio equipment, filters, and interfaces with conventional wire, microwave link or fiber optic cable telephone transmission lines, and other accessory equipment required for the antennae on the tower. The base station will have wireless or hard-wired connections to the service operator's Network Operations Centers (“NOC”s) to permit transmission of signals from the NOC to the antenna, and from the antenna to the NOC.

To insure proper operation of these installations, verification that antennae position and alignment as installed complies with design parameters is necessary, as is monitoring to detect variations from the design parameters caused by weather, slippage or sagging of mounting hardware, or other unanticipated effects. Visual inspection, to detect trees, buildings or other objects which have appeared since the original antenna installation and which may shield or otherwise interfere with the operation of the antenna, is also desirable. Visual inspection of the area covered by a given antenna may also detect otherwise undetected alignment changes, and assist in interpreting alignment data recorded by monitoring alignment parameters. Additionally, with ongoing maintenance operations which may involve replacement of older antennae at a tower, knowledge of equipment installed at a given location, date of installation, model and serial numbers, etc is desirable.

In addition to verification of antenna position and alignment, and identification of equipment inventory, it may be desirable to monitor environmental factors which may influence antenna operation, such as weather conditions, including but not limited to temperature, humidity, rain fall, and wind-speed and direction.

It may also be desirable to monitor various electrical/electronic parameters, particularly those subject to spontaneous variation over time. A particularly troubling problem in antenna operation is deterioration of RF power transmission effectiveness—i.e, increased RF insertion losses—among the electronic components linking the T/C signals from the NOC to the antenna base station, and to the antenna itself, resulting at least in part from corrosion, moisture, or other forms of environmental contamination of connectors and electronic components. Monitoring of the vswr in such linking electronic components would alert provider personnel to the need for maintenance or repair of such connectors or components. In addition, electrical power to antenna sites could also be monitored, to detect outages and allow providers to take corrective action if such outage is detected.

Furthermore, to optimize service coverage, the location and coverage area of each tower must be reviewed frequently on both a local and regional level, to take into account planned service improvements, changing demographics, construction of new structures which may interfere with antennae operation, and installation of new towers.

New developments in cell phone technology, such as the ability to alert a user of automotive service facilities, restaurants, shops etc. in his/her vicinity; the requirement that the geographical location from which 911 calls originate be accurately determined; and the increasing use of mobile signal-strength and performance monitoring equipment (“Can you hear me now?”); all put a priority on having accurate antennae location and alignment information continuously available.

Verification and monitoring of antenna parameters, including geographic position and elevation, alignment, visual information, and inventory, generally requires that maintenance personnel climb towers which may be more than 100 ft. high, or gain access to installations on the exposed exterior of tall buildings. Such verification is expensive, because of the time needed to gain access to the antenna, and is, in many cases, hazardous.

There is clearly a need for a system for monitoring and verifying the parameters of a very large number of individual antenna, and making information on the parameters available at the, base station serving the antenna, and at the service provider's NOCs and local and regional offices in whose territory the antenna is located. Because of the expense and hazard of physically accessing the antennae, any such system must be highly reliable, and the large number of antennae dictates a relatively low-cost system. A readout of antenna parameters should be available at the base station of the installation, and preferably, via remote transmission, also at the NOCs and local and regional offices of the provider. In addition, identifying information on the equipment installed in the base station, as well as pertinent environmental (weather) conditions and electrical/electronic parameters indicative of proper operation should similarly be available.

For maximum utility data from such monitoring system should be assembled and tabulated in a data base in a form readily available to the provider's engineering and maintenance personnel. It may also be desirable to identify, for each monitored antenna, the general geographic area or zone for which the antenna in question is designed to provide telecommunications services, although it will be appreciated that there will be considerable overlap of antenna coverage, especially in regions near the edges of the target areas.

The present invention provides a system to meet those criteria

It should be noted that the radiation pattern of an antenna may, in some cases, be “steered” electronically, as taught, for example, by Runyon et al. in U.S. Pat. No. 6,864,837. In such case, determining and reporting of the primarily mechanical parameters affecting the radiation pattern of an antenna, discussed above, would have to be supplemented by determination and reporting of the electrical or electronic steering parameters affecting the radiation pattern of the antenna being monitored.

Systems exist which will monitor the azimuth and tilt of an antenna, and adjust these parameters in response to remote external commands or internal, remotely adjustable, set-points. Typical of such systems are the inventions disclosed by Wesniak in U.S. Pat. No. 6,864,847 B2, and by Singer et al in U.S. Pat. No. 6,239,744 B1. Such systems are relatively expensive (compared to just monitoring the parameters), and the increased complexity may require additional maintenance. The inventions of Wesniak and of Singer et al do not provide for visual monitoring or inventory recording, or weather or electrical parameter monitoring.

### OBJECTIVES AND SUMMARY OF THE INVENTION

It is an objective of the present invention to provide a system to monitor data relating to telecommunications antennae alignment, environmental conditions and electrical/electronic operation of the antenna and its accessory components, and to identify the type of each monitored antenna and any accessory equipment installed with that antenna, and the inventory of base station equipment in use at the antenna's installation.

It is a further objective of the present invention to provide a system to make such data available by remote connection at the base station serving the antenna, and at the local and regional offices of the provider.

It is a still further objective of the present invention to provide such a system which is economical to fabricate and install and which requires minimal maintenance.

It is a still further objective of the present invention to provide a method of collecting data relative to the geographic location of a T/C antenna, its elevation, the azimuthal, tilt and roll alignment of the antenna, the visual scene “seen” by the antenna, and the inventory of the antenna and its associated equipment (the “installation data”), and weather data and electrical/electronic operating data and providing said data to T/C service providers in a form readily useable by the provider's engineering, maintenance or other personnel.

The present invention achieves these objectives by providing means for determining and reporting three-axis absolute position (i.e., latitude, longitude and elevation), tilt, roll and azimuth of the antenna of interest, as well as a camera image of the visual field “seen” by the antenna, the antenna and base station inventory data, weather data and electrical/electronic operating data. The information of interest may be transmitted to the base of the antenna tower or building upon which the antenna is mounted, and/or transmitted to one or more central locations where a plurality of antennae are monitored.

In another aspect of the present invention, a service is provided to T/C service providers comprising collecting three-axis absolute position (i.e., latitude, longitude and elevation), tilt, roll and azimuth of the antenna of interest, as well as a camera image of the visual field “seen” by the antenna, the antenna and base station inventory data weather data and electrical/electronic operating data, collating the information and providing it to T/C service providers in a convenient format for utilization by the provider's engineering, maintenance or other personnel.

### DETAILED DESCRIPTION OF THE INVENTION

The present invention comprises means to determine the geographic position and elevation of a T/C antenna, means to determine the azimuth of the antenna, means to determine the tilt and roll of the antenna, means to record the visual field the antenna radiates into, means to determine and record the antenna installation data such as serial numbers or other identifying data relating to the antenna and its accessory equipment, means to determine and record identifying data relating to the equipment installed at the base station serving the antenna, means to record weather conditions (including but not limited to temperature, humidity, rain fall, and wind-speed and direction.), means to monitor electric/electronic operation of the antenna and its auxiliary equipment, and means to communicate the information collected by said means to the base station, and also to remote sites.

Two types of the data relating to an antenna which may be determined and transmitted to the base station and/or remote sites may be distinguished: dynamic data, which may change spontaneously or under the influence of environmental factors, such as antenna tilt and roll, visual field, environmental conditions (weather) and electrical/electronic data relating to insertion losses or electrical power availability; and what will be termed herein “installation data”, which is established at the time of initial installation or operation of an antenna, and is changed only by operator or technician intervention. Installation data may include information such as make, model and serial numbers of antennae and ground station components, design or initial values of parameters such as geographic position and elevation. (If tilting, sagging or other gross movements of tower or other supporting structure is possible, geographic position and antenna elevation may change without operator intervention.)

Means to determine the geographic position of the antenna may comprise any of the GPS measuring devices known to the art. In the preferred embodiment, said means may comprise the GPS 25-LVC PhaseTrac 12 Sensor Board module with a Garmin GA 29 remote GPS antenna, both available from Garmin International Inc., 1200 E. 151st Street, Olathe, Kans. 66062-3426. For greater accuracy and precision, the preferred embodiment may also comprise a Garmin GBR 23 Differential Beacon Receiver, available from the same source. The GPS module will provide outputs of latitude, longitude and elevation accurate to about 5 meters or less.

New developments in GPS technology and other technologies relating to geographic position determination have been developed or are under development at the present time. Such advanced technological means may provide significantly more precise determination of position relative to a reference position; and may enable determination of elevation of an antenna relative to a reference position such as the antenna's base station with an accuracy of significantly better than one meter. The present invention contemplates antennae monitoring provisions comprising such differential position-measuring technology.

In an alternate embodiment, the geographic position and elevation and/or antenna height may be determined by any means known to the art, such as map coordinates or street address, with height or vertical distance of the antenna above local ground level determined by measurement by tape measure, transit, laser range-finder, or any of the distance-measurement methods known to the art, at the time the tower is constructed or the antenna installed. In such alternate embodiment, the position and elevation data would be recorded as part of the installation data recorded by the means to determine and record the installation data.

In cases where antenna elevation may be subject to unanticipated change, frequent elevation-above-local-ground-level measurements may be made by a laser range-finder or other distance-measuring means comprised within the antenna or the mounting or attachment hardware fixing the antenna to the tower.

Means to determine the azimuth of the antenna may comprise any of the many direction-measuring devices known to the art. In the preferred embodiment, said means may comprise the Vector 2X or 2Xe magnetic compass modules, available from PNI Corporation, 133 Aviation Blvd, Suite 101, Santa Rosa, Calif. 95403. These modules provide an output of the absolute (i.e., with respect to magnetic north) compass heading. The means to determine the azimuth would be mounted on the antenna support structure (ie., the structural elements used to attach the antenna to the tower), and the azimuthal offset of the mounting with respect to the antenna's radiation pattern axis would be recorded as part of the installation data recorded by the means to determine and record installation data relating to the antenna

Means to determine the tilt of the antenna may comprise any of the many inclinometers known to the art. Such inclinometer would be mounted to the antenna structure so as to determine inclination in a vertical plane containing, or parallel to, the antenna's radiation pattern axis. In the preferred embodiment, said means may comprise the EZ-TILT-2000-30 system inclinometer/tilt detector sold by AOSI of Linden, N.J.

Means to determine the roll of an antenna may similarly comprise an inclinometer mounted to the antenna structure so as to determine inclination in a vertical plane which is normal to a vertical plane containing, or parallel to, the antenna's radiation pattern axis, or, alternatively, in a substantially vertical plane which is normal to the antenna's radiation pattern axis. Alternatively, roll could be determined by a shaft-position-encoder or similar rotation determining sensor, which are well known in the art, said rotation determining sensor being mounted to the antenna support structure in such a manner that any roll of the antenna would similarly affect said sensor. Selection of the most appropriate means to determine roll would depend on the structural details of the antenna and the mounting hardware attaching the antenna to the tower, and such selection is within the purview of one skilled in the art.

Preferably, the means to determine tilt and roll will be mounted on the antenna support structure in such a manner that any change in actual tilt or roll would similarly affect said means. Any tilt or roll offset of said mounting with respect to the antenna's radiation pattern axis or roll “zero” or design alignment, respectively, would be determined and recorded as part of the installation data recorded by the means to determine and record installation data relating to the antenna.

The present invention contemplates monitoring the alignment of antennas for which the radiation pattern can be electonically steered. For such antennas, signals affecting the alignment of the radiation pattern would be measured by means well known in the art, and transmitted to base stations and remote locations. Appropriate installation data relating to the beam-steering parameters would also recorded and transmitted to base stations and remote locations.

Means to record the visual field the antenna radiates into may comprise any of the very many remote camera systems known to the art. Requirements for such systems are modest, since the primary purpose would be to detect any object which would adversely impact the radiation and receiving pattern of the antenna. Such objects, such as foliage from nearby plants, newly erected structures, or construction cranes nearby, for example, would be essentially static or slowly moving, so that high-speed imaging would be unnecessary. Nor would high optical resolution be required, since only relatively large, nearby objects would be of interest. Imaging under daylight conditions would suffice, so that high light sensitivity would be unnecessary. Selection of an appropriate camera system would be determined by such factors as cost, durability, ease of mounting on the antenna support, etc, and one skilled in the art could readily make such selection.

In the preferred embodiment, said means may comprise M/N MVC3000 Miniature Tube Camera, available from Micro Video Products, One Mill Line Road, Bobcaygeon, Ontario, Canada, K0M 1A0.

The present invention also contemplates detecting a power outage to an antenna or its base station, and verifying the optimum electrical operation of the antenna base-station components and connections between such components and to the antenna by measuring the vswr for interconnections. Methods of detecting and or measuring such relevant parameters are well within the purview of one skilled in the art.

The present invention also contemplates measuring relevant weather factors, such as temperature, humidity, rain fall, and wind-speed and direction. Methods of measuring such relevant parameters are also well within the purview of one skilled in the art.

Means to communicate the data relating to the installation's geographic position and antenna elevation/height, data relating to the antenna's azimuthal alignment, data relating to the antenna's tilt and roll, weather conditions and electrical/electronic operation, and installation data to the base station serving the antenna, and also to remote sites (the “data system”) may comprise any of the data logging and transmission systems well known in the art. In preferable embodiments, the data system will comprise a microprocessor to store installation data, and to control measurement and reporting sequences. In the most preferable embodiment, the data system would usually operate under its stored program, but would be controllable and programmable from the base station and the remote sites when necessary. This controllable and programmable feature would enable provider personnel to interrogate the antenna data out of sequence, and to upgrade or otherwise modify the stored program. Also, the design values of azimuth, tilt and roll could be stored in the data system, to assist in later verification of antenna alignment by the provider's maintenance, engineering and administrative and other personnel. Transmission to the base station and remote location could be by means of wireless and/or “land line” methods. In an alternate embodiment, the communication means may comprise an internet-based communication system, such as are well known in the art; in such an internet-based communication system, it may be desirable to assign a unique IP address to each antenna being monitored, to facilitate communication to a base station or remote site.

A cell phone industry group known as the Antenna Interface Standards Group (http://www.bcba15324.pwp.blueyonder.co.uk/) is currently engaged in developing communication protocol standards for use in communications between antennae and remote sites. In preferred embodiments of the present invention, means to communicate the data relating to an antenna and its auxiliary equipment will comprise facilities to conform to such standards as they become available. Incorporation of microprocessor-based means to determine and record the installation data, such as is disclosed below, will facilitate such conformance.

Means to determine and record the installation data, such as serial numbers or other identifying data relating to the antenna and its accessory equipment, comprise devices and methods such as are well known in the art to facilitate capture of the installation data and its storage in local units at the antenna site and/or at remote sites. In a preferred embodiment, all of the components of an antenna installation would carry a bar code, and the technician installing the antenna would scan the bar code of each item using a hand-held scanner connected to the data system, thereby storing the installation data in the data system. The data system may comprise programmed sequences to instruct and/or remind installation personnel to scan in each needed identification datum. In the most preferred embodiment, all of the components of an antenna installation would be equipped with RFID (Radio Frequency Identification) chips; such chips are interrogated by RF transceivers, using devices and methods well-known in the art, to generate a unique electronic signature—in effect an “electronic bar code”—which identifies the chip. The most preferred embodiment of the T/C antenna monitoring system of the present invention would comprise RFID chips and suitable transceivers to uniquely identify the antenna and auxiliary components to which the chip is affixed. Each antenna, or alternatively each group of antennae mounted close together, would have a suitable transceiver.

Similar techniques would be used to identify the base station equipment in use at the tower, and make such data similarly available at base station and remote locations.

With the typical tower installation comprising three or more individual antennae, the antenna monitoring system of the present invention could, in alternate embodiments, comprise some components serving a single antenna and some components serving all of the provider's antennae mounted on the tower. Thus, each individual antenna would comprise means to measure azimuth, tilt, roll and visual field, and antenna installation data would be recorded for each individual antenna, but a single common data system could serve all antennae on a tower and the equipment in the base station in recording and transmitting data on parameters common to all antennae at a given site, such as weather data and electrical power supply to the installation.

The antenna validation system of the present invention could be operated in several different modes. In one mode, a maintenance technician could, in a routine maintenance inspection visit to a tower, verify that all antennae on the tower were properly aligned, that no interfering objects were detected in the antennae's field, and that vswr data were within acceptable limits. Only in the case of a departure from design parameters would the technician need to physically access the antenna and make corrections.

In local and regional providers' offices, data transmitted from all of the provider's antenna could conveniently be stored in a database for easy access. Provider personnel at the offices could easily search for any individual antenna in their area, and verify its installation parameters, inventory and operation status.

A local office may use the data, for example, to schedule periodic maintenance and replacement of components, to plan additional tower installations to improve signal coverage, or to determine the antenna or tower involved in customer or technician reports of inadequate service or outage. Regional offices may use the data for coverage-planning purposes, for financial analysis, and for inventory control. (Accounting and auditing personnel generally do not like to climb cell phone towers.)

In another aspect of the present invention, a service may be provided, as a business enterprise, comprising collecting antenna validation data—i.e., the geographic position, elevation and alignment of a T/C antenna, the visual field the antenna radiates into, the antenna installation data such as serial numbers or other identifying data relating to the antenna and its accessory equipment, identifying data relating to the equipment installed at the base station serving the antenna, weather and electrical/electronic operation data, for a plurality of antennae located at a plurality of locations and owned by a plurality of T/C service providers who are customers or clients of the business enterprise; collating and tabulating such data in a data base; and generating reports for each of the client T/C service providers, giving the antennae validation data of their antennae. The database may be scanned continuously, with reports provided either on demand from the clients or with a predetermined temporal periodicity, or when an exception, or departure from design or initial antennae parameters of more than a predetermined and preassigned “allowable deviation”, is detected.

In order to perform such exceptions monitoring, the monitoring system of the present system may utilize repetitive scanning of the data base of antennae validation data as a “background” task, to facilitate prompt detection of exceptions.

The above disclosure described the use of the present invention in one T/C application: cellular telephony. It will be apparent to one skilled in the art that the invention is applicable to any other T/C application requiring the use of antennae which must be accurately positioned and aligned, and the present invention contemplates the use in such other applications.

Other embodiments will be apparent to one skilled in the art, which will change various details of the present invention without limiting its scope. Furthermore, the foregoing description of the preferred embodiment of the invention and the best mode for practicing the invention are provided for the purpose of illustration only and not for the purpose of limitation of the invention, which will be defined by the claims appended hereto.

1. A system for determining positional, alignment and operating parameters of a telecommunications antenna, comprising:
providing said antenna with means to determine the geographic position (i.e., latitude and longitude) of said antenna;
providing said antenna with means to determine the height of said antenna;
providing said antenna with means to determine the azimuthal alignment, tilt and roll of said antenna;
providing said antenna with means to determine the installation data for said antenna;
providing said antenna with communication means to transmit said positional, alignment, visual and installation data to a remote location.

2. The system of claim 1 wherein said means to determine the geographic position of said antenna comprise GPS determining means;

3. The system of claim 1 wherein said means to determine the height of said antenna comprise measuring the height of said antenna and recording said measured height as part of said installation data.

4. The system of claim 1 further comprising providing said antenna with means to produce a visual image of the region into which said antenna radiates, or from which it receives signal radiation.

5. The system of claim 4 wherein said means to produce a visual image are aimed in the direction of the beam from said antenna.

6. The system of claim 1 further comprising means to verify the electrical power supply to an antenna and its associated base station.

7. The system of claim 1 further comprising means to determine the vswr of RF power transmission to said antenna.

8. The system of claim 1 further comprising means to determine temperature, humidity, rain fall, and wind-speed and direction in the vicinity of said antenna.

9. The system of claim 1 wherein said communication means further comprise means to transmit said verification of electrical power supply, said vswr of RF power transmission, and said temperature, humidity, rain fall, and wind-speed and direction in the vicinity of said antennas to said remote site.

10. The system of claim 1 wherein said communication means further comprise means for identifying said antenna by a unique IP address.

11. A method of improving the operation of telecommunications antennae, comprising:
determining the positional, alignment, and installation data of a plurality of telecommunications antennae and transmitting said data to a remote site;
collating and tabulating said data in a data base;
entering the design positional, alignment, visual, and installation parameters of said plurality of telecommunications antennae into said data base;
determining whether said data from each of said plurality of telecommunications antennae is within predetermined allowable deviation from said design parameters;
generating reports from said data base comprising listing of each of the said plurality of telecommunications antennae together with the positional, alignment, visual, and installation data determined for each of the said plurality of telecommunications antennae, and identifying which of said plurality of telecommunications antennae are not within predetermined allowable deviation from said design parameters.

12. The method of claim 7 further comprising determining a visual image of the region into which said antenna radiates, or from which it receives signal radiation, and transmitting said visual image to said remote site.

13. The method of claim 7 further comprising determining the temperature, humidity, rain fall, and wind-speed and direction in the vicinity of said antenna.

14. The method of claim 7 further comprising verifying the integrity of the electrical power supply to an antenna and its associated base station.

15. The method of claim 7 further comprising determining the vswr of RF power transmission to said antenna.

16. An enterprise for improving the operation of telecommunications antennae, comprising:
determining the positional, alignment, visual, and installation data of a plurality of telecommunications antennae operated by a client of the enterprise, and transmitting said data to a remote site;
collating and tabulating said data in a data base;
entering the design positional, alignment, visual, and installation data of said plurality of telecommunications antennae operated by a client of the enterprise into said data base;
determining whether said positional, alignment, visual, and installation data for each of said plurality of telecommunications antennae operated by a client of the enterprise is within predetermined allowable deviation from said design parameters;
generating reports from said data base for each client of the enterprise comprising listing of each of the said plurality of telecommunications antennae operated by said client, together with the positional, alignment, visual, and installation data determined for each of the said plurality of telecommunications antennae, and identifying which of said plurality of telecommunications antennae operated by a client of the enterprise are not within predetermined allowable deviation from said design parameters.

17. The enterprise of claim 11 further comprising determining a visual image of the region into which said antenna radiates, or from which it receives signal radiation, and transmitting said visual image to said remote site.

18. The enterprise of claim 11 further comprising determining the temperature, humidity, rain fall, and wind-speed and direction in the vicinity of said antenna and transmitting said visual image to said remote site.

19. The enterprise of claim 11 further comprising verifying the availability of the electrical power supply to an antenna and its associated base station and transmitting said verification to said remote site.

20. The enterprise of claim 11 further comprising entering a predetermined threshold value of the vswr of RF power transmission to each of said plurality of telecommunications antennae into said data base;
determining whether said vswr of RF power transmission to each of said plurality of telecommunications antennae operated by a client of the enterprise is within predetermined allowable deviation from said vswr threshold value;
determining whether electrical power is available to each of said plurality of telecommunications antennae operated by a client of the enterprise;
alerting a client of the enterprise if the deviation of said vswr of RF power transmission to any of said plurality of telecommunications antennae operated by said client exceeds said threshold value by more than said allowable deviation; and
alerting a client of the enterprise of the absence of electrical power to any of said plurality of telecommunications antennae operated by said client.
